(19) United States
(12) Patent Application Publication
(10) Pub. No.: US 2021/0036381 A1
(43) Pub. Date: Feb. 4, 2021

(54) MILLING OF RECOVERED NEGATIVE ELECTRODE MATERIAL

(71) Applicant: Nilar International AB, Täby (SE)

(72) Inventor: Dag NORÉUS, Saltsjö-Duvnäs (SE)

(73) Assignee: Nilar International AB, Täby (SE)

(21) Appl. No.: 16/767,021

(22) PCT Filed: Nov. 28, 2018
(86) PCT No.: PCT/SE2018/051226

§ 371 Date: May 26, 2020

(30) Foreign Application Priority Data
Nov. 28, 2017 (SE) 1751459-7

(51) Int. Cl. H01M 10/34; H01M 4/24; H01M 4/38

(52) U.S. Cl. CPC H01M 10/345; H01M 2004/027; H01M 4/383; H01M 4/242

(57) ABSTRACT

The present disclosure concerns a method of producing an activated negative electrode powder for use in nickel-metal hydride (NiMH) batteries, the method comprising the steps: a) providing at least one previously cycled NiMH battery; b) isolating a negative electrode powder from the previously cycled NiMH battery; c) wet-milling or milling the negative electrode powder, thereby obtaining a mixture of the activated negative electrode powder and a byproduct rich in rare earth hydroxides; and d) separating the activated negative electrode powder from the byproduct. The disclosure further relates to an activated negative electrode powder produced by the said method, as well as battery electrodes and batteries comprising such a powder.

### TECHNICAL FIELD

The present invention relates to a method of producing an activated negative electrode powder for use in nickel-metal hydride (NiMH) batteries. The invention further relates to an activated negative electrode powder produced by the said method, as well as battery electrodes and batteries comprising such a powder.

### BACKGROUND ART

The use of secondary batteries is becoming increasingly prevalent, due in part to trends in society such as vehicle electrification and pervasive use of mobile consumer electronics. Since their commercial introduction in the late 1980s, nickel-metal hydride (NiMH) batteries have been widely adopted in a variety of applications due to favourable properties such as high energy density, long service life, good charge rate, and relative environmental benignancy. However, there remains a need to develop batteries with improved properties.

A NiMH battery cell typically comprises at least one positive electrode and at least one negative electrode separated by a separator between the electrodes. Much development has been focussed on both the positive and negative electrode materials.

The negative electrode typically comprises hydrogen storage alloy powder as the active component. In order to improve the properties of the negative electrode, the hydrogen storage alloy may be activated either prior to electrode manufacture or after. A number of such activation methods are known.

For example, patent U.S. Pat. No. 7,056,397 B2 discloses a method for improving the properties of a hydrogen storage alloy powder. The method comprises the steps of hydriding a powdered alloy starting material having the composition Mm (Ni, Co, Al, Mn)₅, wherein Mm denotes mischmetal, by exposing the material to hydrogen, then oxidising the obtained hydride alloy powder, and washing the oxidised powder.

The negative electrodes in an NiMH battery become increasingly oxidized throughout the usage lifespan of the battery, leading to a decrease in battery capacity, and a drying-out of the battery electrolyte as the electrolyte is consumed in the oxidation process leads to an increased internal resistance. Eventually, the performance of the battery is compromised to such an extent that replacement of the battery is required.

Therefore, with increasing use of NiMH batteries there also arises a need for efficient recycling of the materials used in order to reduce the ecological burden of disposal of spent batteries and production of new batteries. Recycling efforts have typically focussed on extraction of pure metallic elements such as nickel, or rare earth ores from the used batteries by hydrometallurgical and/or pyrometallurgical methods. Although this may allow for some of the major battery metals to be recycled, a substantial proportion of the available metals will not be recycled due to the high cost and limited efficiency of existing methods.

There remains a need for improved means of producing negative electrode materials for NiMH batteries. Moreover, there remains a need for improved methods of recycling used NiMH batteries.

### SUMMARY OF THE INVENTION

The inventor of the present invention has identified deficiencies in the prior art. Prior art means of producing hydrogen storage alloys typically proceed from the unalloyed metals and require substantial energy inputs for melting and blending of the alloy. Depending on the hydrogen storage alloy desired, it can be challenging to obtain the correct alloy phase or phases during production, and thus time-consuming and onerous control over the production process is often required. Moreover, prior art means of further activating the obtained hydrogen storage alloys typically require the use of numerous chemical treatment steps such as hydriding, oxidation and washing of the alloy powder, leading to a complex and relatively inefficient process requiring disposal or recycling of numerous chemical reagents. Furthermore, prior art means of recycling the rare earth fraction of used NiMH batteries typically results in rare earth oxides being obtained, that then require extensive pyrometallurgical treatment in order to obtain fresh hydrogen storage alloy powder.

It is thus an object of the present invention to provide a method of producing an active hydrogen storage alloy directly from secondary materials from used NiMH batteries, without the need for extensive pyrometallurgical, hydrometallurgical or chemical treatment steps.

These objects are achieved by a method of producing an active negative electrode powder according to the appended claims.

The method comprises the steps:

a) providing at least one previously cycled NiMH battery;

b) isolating a negative electrode powder from the previously cycled NiMH battery;

c) wet-milling or milling the negative electrode powder, thereby obtaining a mixture of the activated negative electrode powder and a byproduct rich in rare earth hydroxides; and

d) separating the activated negative electrode powder from the byproduct.

The method is based on the insight that despite the negative electrode powder being passivized throughout the active service life of the battery, the main part of the inner hydrogen storage alloy particles in the negative electrode is however still intact and a highly active continuous corrosion layer is formed beneath the passivation layer. By removing the passivation layer through wet-milling while leaving the continuous corrosion layer substantially intact, a highly active negative electrode powder may be obtained. This activated negative electrode powder is produced without extensive use of chemicals and is suitable for reuse in batteries without requiring re-melting. Because no re-melting is required, the problems associated with melting, such as excessive energy consumption and difficulties in obtaining the correct phase, are avoided.

The wet-milling in step c) may be performed by means of ultrasonication, ball-milling, disc-milling or jet milling, all of which are robust, well-proven means of treating particulate material. The wet-milling in step c) may preferably be performed by ball-milling or ultrasonication. Ball-milling or ultrasonication provides suitable erosion of the powder surface without excessive concurrent comminution of the particle size. The wet milling may be performed for a period of time sufficient to obtain an activated negative electrode powder having a discharge capacity that is at least 80%, preferably at least 90%, of a discharge capacity of freshly manufactured negative electrode powder when measured under the same conditions. Such conditions may for example be discharging in half cell at a rate of 0.2 C to a final voltage of −0.75 V vs zinc electrode reference electrode or discharging at a rate of 1 C to a final voltage of −0.9V vs zinc reference electrode. A discharge rate of xC corresponds to a time for complete discharge of 1/x hours. Thus, depending on the nature of the negative electrode powder used the capacity of the negative electrode powder may substantially match the capacity of virgin negative electrode powder manufactured from melt.

The previously cycled NiMH battery used in the method may have undergone from about 1 to about 20 cycles. Thus, for example, material from batteries that have undergone formation but failed quality control may be used. The active negative electrode powder obtained from processing such batteries has excellent capacity, thus allowing for an efficient reuse of material from rejected batteries without a need for excessive reprocessing.

The previously cycled NiMH battery used in the method may have undergone from about 21 cycles to about 2000 cycles, or more than 2000 cycles. Thus, for example, waste batteries at the end of their useful service life may be easily and efficiently recycled.

The negative electrode powder being treated may comprise a hydrogen storage alloy selected from the group consisting of AB alloys, AB₅ alloys, AB₂ alloys, AB₃ alloys, A₂B₇ alloys and A₅B₂₂ alloys. Thus, all commonly investigated and commercially implemented hydrogen storage alloys may be processed by the method disclosed. The negative electrode powder may comprise at least 50 wt %, more preferably at least 70 wt %, most preferably at least 80% of a hydrogen storage alloy.

The negative electrode powder may further comprise unalloyed nickel. Thus, there is no need to isolate the hydrogen storage alloy from other materials in the negative electrode powder prior to processing.

The method may further comprise a step e) of washing the activated negative electrode powder. This may assist in further reducing the amount of waste rare earth oxides in the finally obtained powder. The method may further comprise a step f) of drying the activated negative electrode powder. The method may further comprise a step g) of sieving the activated negative electrode powder in order to remove the smallest particles, such as particles smaller than 3 μm or particles smaller than 5 μm.

According to another aspect of the present invention, the objects of the invention are attained by an activated negative electrode powder according to the appended claims.

The activated negative electrode powder may be obtained by the method disclosed herein.

The activated negative electrode powder may have an average particle size as measured by Scanning Electron Microscopy (SEM) of 30 μm or less, such as about 25 μm or less, such as about 20 μm of less.

The activated negative electrode powder may have a primary mode in a differential particle size number distribution of about 14 μm or less, such as about 13 μm or less, or about 10 μm or less. This is significantly smaller than the mode of the powder prior to treatment.

The activated negative electrode powder may comprise at least 50 wt %, more preferably at least 70 wt, most preferably at least 80 wt %, of a hydrogen storage alloy. The hydrogen storage alloy may be selected from the group consisting of AB alloys, AB₅ alloys, AB₂ alloys, AB₃ alloys, A₂B₇ alloys and A₅B₂₂ alloys.

The activated negative electrode powder may have a corrected discharge capacity of at least 300 mAh/g when discharged in a test cell at a rate of 0.2 C. Thus, the activated negative electrode powder may have a discharge capacity substantially equivalent to virgin negative electrode powders manufactured directly from melt.

According to a further aspect of the present invention, the objects of the invention are attained by a battery electrode comprising an activated negative electrode powder as described herein. The battery electrode may further comprise a freshly manufactured negative electrode powder.

According to yet another aspect of the present invention, the objects of the invention are attained by a battery comprising an activated negative electrode as described herein.

Further objects, advantages and novel features of the present invention will become apparent to one skilled in the art from the following detailed description.

### BRIEF DESCRIPTION OF THE DRAWINGS

For a fuller understanding of the present invention and further objects and advantages of it, the detailed description set out below should be read together with the accompanying drawings, in which the same reference notations denote similar items in the various diagrams, and in which:

FIG. 1 is a process flowchart illustrating the method of producing an activated negative electrode powder.

FIG. 2A is a chart illustrating the discharge capacity of various electrodes formed from treated and untreated negative electrode powders when discharged at a rate of 0.2 C.

FIG. 2B is a chart illustrating the discharge capacity of various electrodes formed from treated and untreated negative electrode powders when discharged at a rate of 1 C.

FIG. 3 is a chart illustrating the discharge capacity during the initial 10 discharge cycles of various electrodes formed from treated and untreated negative electrode powders when discharged at a rate of 0.2 C.

FIG. 4 is a schematic illustration of the surface of a corroded hydrogen storage alloy.

FIG. 5A is a SEM image showing the surface of an untreated hydrogen storage alloy particle recovered from waste batteries.

FIG. 5B is a SEM image showing the surface of an ultrasound-treated hydrogen storage alloy particle recovered from waste batteries.

FIG. 6A is a SEM image showing the surface of an untreated hydrogen storage alloy particle recovered from batteries that failed quality-control.

FIG. 6B is a SEM image showing the surface of an ultrasound-treated hydrogen storage alloy particle recovered from batteries that failed quality-control.

FIG. 7 is a powder diffractogram comparing a byproduct isolated from the water after ultrasound treatment of a negative electrode powder with lanthanum hydroxide.

FIG. 8 is a chart illustrating the discharge capacity of various electrodes formed from treated and untreated negative electrode powders when discharged various rates.

FIG. 9A is a chart of the particle size distribution obtained by SEM analysis of an untreated “Cycled” negative electrode powder recovered from waste batteries.

FIG. 9B is a chart of the particle size distribution obtained by SEM analysis of a fresh “Formation” negative electrode powder.

FIG. 9C is a chart of the particle size distribution obtained by SEM analysis of a ball-mill treated negative electrode powder recovered from waste batteries.

FIG. 9D is a chart of the particle size distribution obtained by SEM analysis of a small-scale ultrasound treated negative electrode powder recovered from waste batteries.

### DETAILED DESCRIPTION

The present invention is based upon the inventor's insight that although the hydrogen storage alloy of a negative electrode of a battery cell undergoes passivation during the battery's operational life, an activated corrosion layer enriched with catalytic nickel clusters is formed beneath the passivized surface. By removing the passivation layer, the activated corrosion layer is exposed, thus providing a hydrogen storage powder that can match or even in some circumstances exceed the discharge properties of freshly manufactured hydrogen storage powder.

Each cell of a NiMH battery typically comprises one or more negative electrodes. The negative electrodes may be manufactured by a number of methods. A negative electrode powder may be deposited on an electrode substrate using for example a dry compaction method, a wet paste method or a dry paste method. The substrate may comprise nickel, for example, nickel powder, nickel foam, nickel mesh or nickel-plated perforated steel plate, although other substrates are known in the art. Alternatively, an electrode is formed without substrate from a negative electrode powder, optionally incorporating a scrim to improve the mechanical integrity of the formed electrode. Regardless of the method of manufacturing used, the negative electrode powder used in manufacturing typically comprises a hydrogen storage alloy in quantities in excess of 70 weight %, wherein weight % is defined as dry weight of the hydrogen storage alloy powder in relation to the total weight of the negative electrode material. Other materials present in the negative electrode powder may include nickel powder, for example dendritic nickel powder produced by the nickel carbonyl process.

Hydrogen storage alloys are alloys capable of reversibly storing hydrogen by conversion to the corresponding metal hydride. The half-cell reaction occurring at the negative electrode is thus:

M+H2O+e−⇄MH+OH—

The hydrogen storage alloys typically used in MiMH batteries are intermetallic alloys of the AB type, such as AB, AB₅, AB₂, A₂B₇, AB₃ and A₅B₂₂, wherein A is a more electropositive metal prone to form a hydride and whereas B is is a less electropositive element less prone to form a hydride.

In AB₅ and A₂B₇, AB₃ and A₅B₂₂ alloys the hydride forming metal A is typically one or more rare earth (RE) metal, such as La, Ce, Nd, Pr, Y, or a mixture of rare-earths known as mischmetal (denoted Mm). The non-hydride forming component B is typically nickel, and is usually doped with other metals such as cobalt, manganese and aluminium in order to improve the charge/discharge and stability properties of the alloy. Further elements such as silicon may be included in the alloy.

Method

According to the method of the present invention, an activated negative electrode powder is produced from used NiMH batteries. For example, the negative electrode powder to be processed by the present method may comprise, essentially consist of, or consist of hydrogen storage alloy, such as AB₅ alloy, and optionally nickel powder.

The produced activated negative electrode powder is suitable for use in the production of new NiMH batteries, but may also find use in other applications requiring hydrogen storage technology, such as in association with hydrogen fuel cells applications.

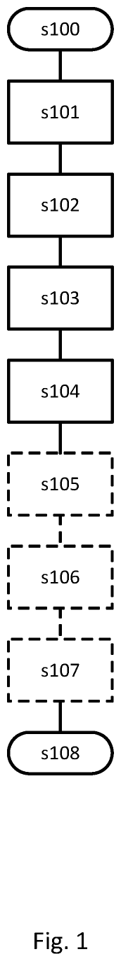

The method comprises the following steps, as illustrated by FIG. 1. Step s100 denotes the start of the process and step s108 denotes the end of the process. In step s101 at least at least one previously cycled NiMH battery is provided. In step s102 a negative electrode powder is isolated from the at least one battery provided in s101. In step s103 the powder isolated in s102 is wet-milled or milled, thereby obtaining a mixture of an activated negative electrode powder and a byproduct rich in rare earth hydroxides. In step s104 the activated negative electrode powder is separated from the byproduct. Further steps may be performed as part of the inventive method. For example, a step s105 of washing the activated powder isolated in step s104 may be performed, a step s106 of drying the powder may be performed, and a step s107 of sieving the isolated activated negative electrode powder may be performed in order to provide a powder with a desired size distribution.

The NiMH batteries used for production of the activated negative electrode powder have been previously cycled. The term “battery” in this context includes single electrochemical cells used to furnish electric current, as well as a plurality of cells connected to furnish electric current. The batteries may have been cycled only a relatively small number of times, such as from about 1 to about 20 cycles, they may have been cycled a relatively large number of times, such as up to about 2000 cycles or more, or they may have undergone an intermediate number of cycles, such as from 21-500 cycles or from 21-1000 cycles. For example, batteries at the end of their operative service life may be used, as may batteries that have undergone only formation and quality analysis (QA) cycles. A mixture of batteries having undergone various amounts of cycles may be used. By cycle it is meant that the battery has undergone the equivalent of one complete charge/discharge cycle.

In order to produce an activated negative electrode powder from the batteries to be recycled, the negative electrode powder from the batteries is then isolated. This may be performed by dismantling the batteries and separating the intact negative electrode, for example where the battery has a modular construction. The negative electrode powder may then be isolated by removal of any electrode substrate material or scrim.

Alternatively, the battery may be mechanically disintegrated and the negative electrode material recovered by physical, mechanical and/or chemical methods from the resulting disintegrated mixture.

Once isolated, the negative electrode powder is subjected to wet-milling or milling. By wet-milling it is meant a process in which particles are treated in a liquid by shearing, by impact, by crushing, or by attrition. The wet milling is thought to remove the passivation layer, which mostly comprises needles of rare earth hydroxides formed on the surface of the hydrogen storage alloy. Without wishing to be bound by theory it is thought that due to electrochemical cycling of the negative electrode material through use in the battery, a highly active layer rich in nickel nanoparticles is formed directly beneath the passivation layer. By removing the passivation layer, this highly active nickel-rich layer is uncovered, thus furnishing the obtained negative electrode powder with excellent charge/discharge properties.

When wet-milling the negative electrode powder it is desirable to obtain erosion of the passivated particle surface without excessive concomitant comminution of the particles. Any suitable wet-milling technique may be used, including but not limited to ultrasonication, ball-milling, disc-milling or jet milling. Both ball-milling and ultrasonication has been found to provide excellent removal of the passivizing rare-earth hydroxide needles and de-agglomeration without excessive particle size reduction. The milling liquid used in the wet milling may be any liquid known in the art, such as an aqueous milling liquid, for example water.

Alternatively, the negative electrode powder may be subjected to another form of milling that achieved the same effect as the wet milling without the need for a milling liquid. Such forms of milling include milling under vacuum or milling in an inert atmosphere. Inert atmosphere in this respect means an atmosphere preventing oxidation of the negative electrode material, such as a nitrogen or argon atmosphere.

The optimal period of (wet)-milling depends on a number of factors including the nature and condition of the negative electrode powder and the milling technique used. Excessive milling may result in degradation of the properties of the negative electrode powder, possibly due to excessive particle size reduction or erosion of the highly active layer beneath the passivation layer. It is within the ability of the skilled person to determine an optimal period for milling.

After milling, the resulting activated negative electrode powder should be separated from the rare earth hydroxide needles that have been detached from the surface of the powder. Depending on the milling liquid used, these rare earth needles may be suspended in the liquid or they may settle in the liquid. The negative electrode powder may be isolated by decantation or filtration. Following isolation, the activated negative electrode powder may be further purified by washing, then dried.

It may be desirable to remove the smallest particles resulting from the production of the activated negative electrode powder. This may for example be performed by sieving the obtained powder prior to storage or introduction into a production line.

Activated Negative Electrode Powder

By the method described above it is found that an activated negative electrode powder may be obtained. Such obtained negative electrode powders may have discharge capacities equal or in some cases even higher than negative electrode material freshly manufactured from melt. For example, activated negative electrode powder produced from batteries deemed to be at the end of their useful operational life, i.e. disposed batteries, may have a discharge capacity more-or-less equal to that of freshly manufactured powder that has undergone only formation and/or QA cycles only. Activated negative electrode powder produced from batteries having undergone only formation and/or QA cycles, i.e. batteries rejected directly from production, may have a discharge capacity in excess of that of freshly manufactured powder that has undergone only formation and/or QA cycles without being treated according to the inventive method.

The inventive method may also give rise to a negative electrode powder having an altered particle size distribution as compared to prior art powders. For example, the average (mean) particle size is smaller for wet-milled materials than for untreated materials. The average (mean) particles size may for example be less than 30 μm, such as about 20 μm or less, or about 15 μm or less. It is observed that the powder resulting from the method has a greater positive skew and peakedness as compared to a powder that has not undergone such treatment. Without wishing to be bound by theory, this may be due in part to a greater propensity of the larger particles in the powder to split (fission) during wet milling. The altered particle size may be observed in any number of parameters used to characterise particle size, including the mean particle size, median particle size, mode particle size (i.e. primary mode of the particle size distribution curve), as well as the powder D₁₀, D₅₀ and D₉₀ values. Dₓ represents the particle diameter corresponding to x% cumulative undersize particle size distribution. For example, if particle size D₅₀ is 12 μm, then 50% of the particles in the powder are smaller than 12 μm.

The increased positive skew may be measured using any commonly known statistical means for determining skew. Since for powders it is common to determine cumulative distribution D₁₀, D₅₀ and D₉₀ values, a useful means of determining skewness of the powder may be Kelley's coefficient of skewers S:

$$S = \frac{{D}_{90} + {D}_{10} - 2 {D}_{50}}{{D}_{90} - {D}_{10}}$$

The negative electrode powder produced by the method of the invention may have an increased skewness coefficient S as compared to prior art powders. For example, the negative electrode powder may have a skewness coefficient S, determined as shown above, which is at least 5% greater, such as at least 10% greater, than the skewness coefficient S of a comparable virgin negative electrode powder.

The increased peakedness of the particle size distribution may be measured using any commonly known statistical means for determining peakedness. For example, the peakedness may be expressed as the ratio of the y-value at the mode, mean or median of the differential particle size distribution curve to the y-value at the 90^{th} percentile of the particle distribution curve, i.e. peakedness P=Y_{M}/Y₉₀ wherein Y_{M} is the y-value of the differential particle distribution curve at the mode, mean or median of the particle distribution curve and Y₉₀ is the y-value of the particle distribution curve at the 90^{th} percentile of the differential particle distribution curve.

The negative electrode powder produced by the method of the invention may have an increased peakedness P as compared to prior art powders. For example, the negative electrode powder may have a peakedness P, determined as the ratio of the y-value at the mode of the differential particle size distribution curve to the y-value at the 90^{th} percentile of the particle distribution curve which is at least 5% greater, such as at least 10% greater, than the peakedness P of a comparable virgin negative electrode powder.

When measuring the particle size distribution and determining a particle size distribution curve, any suitable method may be used including sieving, optical means such as laser diffractometry, and imaging means. The resulting distribution obtained may be on a mass, volume, area or number basis. For example, the particle size distribution may be obtained by automated analysis of images obtained by scanning electron microscopy (SEM) and the resulting particle size distribution may be on a number (count) basis. Parameters characterising the powder, such as D₁₀, D₅₀, D₉₀, skewness S and peakedness P values, may then be determined on a number basis.

### EXAMPLES

### Negative Electrode Materials

Two different previously cycled negative electrode powders were used, one denoted “Cycled” and the other “Formation”. Both of these powders consisted of a mixture of about 90 wt % AB₅ alloy (having a nominal composition of La_{0.57}Ce_{0.31}Pr_{0.03}Nd_{0.09}Ni_{3.67}Al_{0.29}Mn_{0.36}Co_{0.68}) and 10 wt % dendritic nickel. The powders were mechanically recovered from electrode plates of previously cycled batteries. The powder denoted “Cycled” was recovered from batteries deposited at the end of their active service life, i.e. having undergone at least 700 cycles of more, whereas the powder denoted “Formation” was recovered from batteries that had undergone a number of formation cycles but that were rejected during quality control, i.e. had not entered active service.

The ability of wet-milling treatment to regenerate the discharge capacity of the powders was investigated. The powder denoted “Cycled” was treated using ball-milling or the small-scale ultrasonification method described below, whereas the powder denoted “Formation” was treated using both the small-scale ultrasound treatment or the large-scale ultrasound treatment detailed below.

For comparative purposes, the “Cycled” powder was also treated with aqueous lithium hydroxide as described below.

Ball-Milling

For the mechanical treatment, approximately 20 g of “Cycled” material was high-energy ball-milled for 15 minutes with 10 mL of deionized (DI) water, giving a dark-gray suspension above a layer of electrode material. The mixture was then transferred to a 250-mL beaker and stirred for one minute. It was then left to settle for one minute as to achieve a rough separation, with larger and/or denser particles precipitating onto the bottom of the beaker. The liquid content and the still suspended particles were poured off (saved for further analysis) and the remaining thick slurry was transferred to a glass frit and washed with 50 mL of DI water. It was then dried under vacuum for 4 hours, yielding a fine metallic powder. The material loss corresponded to 1.8% of the initial weight.

Small-Scale Ultrasonic Treatment

For the ultrasonic (US) treatment carried out on a small scale (Bandelin Sonorex R31), 5 g of negative electrode powder was put into a 25 mL beaker together with 15 mL of de-ionized (DI) water, and the mixture was treated in an ultrasonic bath for 30 minutes, giving a total power input of 160 mWh mL⁻¹. After the treatment, the acquired light-gray suspension was poured off and the remaining powder rinsed with 10 mL of DI water and dried under vacuum for 4 hours. The mass loss during the ultrasonic treatment was approximately 0.9%.

Large-Scale Ultrasonic Treatment

The large-scale trial (LB) (UD800SH Bath) was carried out on approximately 600 g of previously obtained “Formation” negative electrode material, divided into three 1 L beakers of which each was filled with 500 mL of DI water. The water bath, with a total volume of 23 L, was filled with 10 L of DI water. Ultrasonication was carried out during 1 hour, giving a total power input of 80 mWh mL⁻¹. Similarly as in the small-scale trials, the water was decanted and the powder was dried under vacuum for a total of 6 hours.

Half-Cell Testing in a Three-Electrode System

The electrodes tested were made in the form of pellets, 1 cm in diameter and pressed at 250 MPa, giving a thickness of approximately 2.0 mm. The pellets consisted of 0.25 g MH and 0.75 g high surface area nickel powder (Nickel Powder Type 255, Vale). The pellet was then enclosed in a nickel net (100 mesh) and pressed gently (75 MPa) to achieve contact between the two surfaces. The reference electrode used was Zn/Zn(OH)₄^{2—}(−1.22 vs. SHE) and the counter electrode was made from 20 mesh nickel spot-welded to a nickel wire. The electrolyte used was 6 M KOH. The electrodes were charged at 15 mA for 6 hours (corresponding to a maximum capacity of 360 mAh g⁻¹) and then discharged at 0.2 C for 10 cycles. They were then discharged at 1 C, 2 C, 4 C and 8 C, for 5 cycles per discharge rate. The cut-off voltages were +0.75 V, +0.9 V, +1.1 V and +1.2 V vs. Zn/Zn(OH)₄^{2—}, respectively, for each rate. The half-cell measurements were performed using Lanhe CT2001A (Land) battery testing instruments. For each method of treatment, at least 3 half-cells were made.

Morphological and Structural Characterization

X-ray powder diffractograms of the treated and untreated material were acquired using an X′Pert Pro diffractometer (Cu Kα, λ=1.5418740 Å). Scanning Electron Microscopy (SEM) micrographs and Energy Dispersive Spectroscopy (EDS) data were acquired using a JEOL 7401F Field-Emission Scanning Electron Microscope, a JEOL 7400F analytical SEM setup and a Hitachi TM3000 table top SEM (for particle size assessments). For the cross-section imaging, the powder samples were mixed with a conductive carbon cement and polished using a JEOL SM-09010-CP cross-section polisher.

Results

Results from half-cell measurements are presented below, together with morphological studies. A study of particle size of the treated materials was also conducted using acquired SEM images.

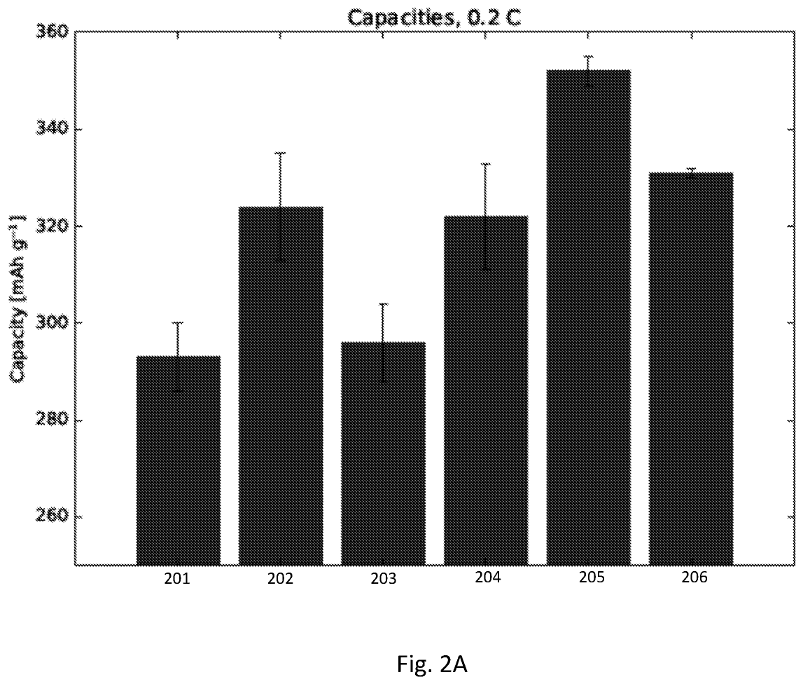

FIG. 2a shows the cycling results for discharge at 0.2 C in the half cell measurements described above. The discharge capacities of the various materials are expressed in mAh g^{-1—} and are corrected to account for the quantity of unalloyed nickel present in the powders. Column 201 represents the untreated “Cycled” material, column 202 represents the small-scale ultrasound treated “Cycled” material, column 203 represents the LiOH treated “Cycled” material, column 204 represents the untreated “Formation” material, column 205 represents the small-scale ultrasound treated “Formation” material and column 206 represents the large-scale ultrasound treated “Formation” material. The error bars represent the 2σ range for the three half-cell measurements of each material. The relative increase in capacity for untreated vs. small-scale ultrasound treatment material is approximately 10% for the “Cycled” powder as well for the “Formation” powder. The increase in capacity achieved by the large-scale treatment (col. 206) was approximately 5%.

FIG. 2b shows the cycling results for discharge at 1 C. The discharge capacities of the various materials are expressed in mAh g^{-1—} and are corrected to account for the quantity of unalloyed nickel present in the powders. Column 201 represents the untreated “Cycled” material, column 202 represents the small-scale ultrasound treated “Cycled” material, column 203 represents the LiOH treated “Cycled” material, column 204 represents the untreated “Formation” material, column 205 represents the small-scale ultrasound treated “Formation” material and column 206 represents the large-scale ultrasound treated “Formation” material. The error bars represent the 2σ range for the three half-cell measurements of each material. Similar trends, as well as the same relative capacity gains, as in FIG. 2a can be seen between the different materials.

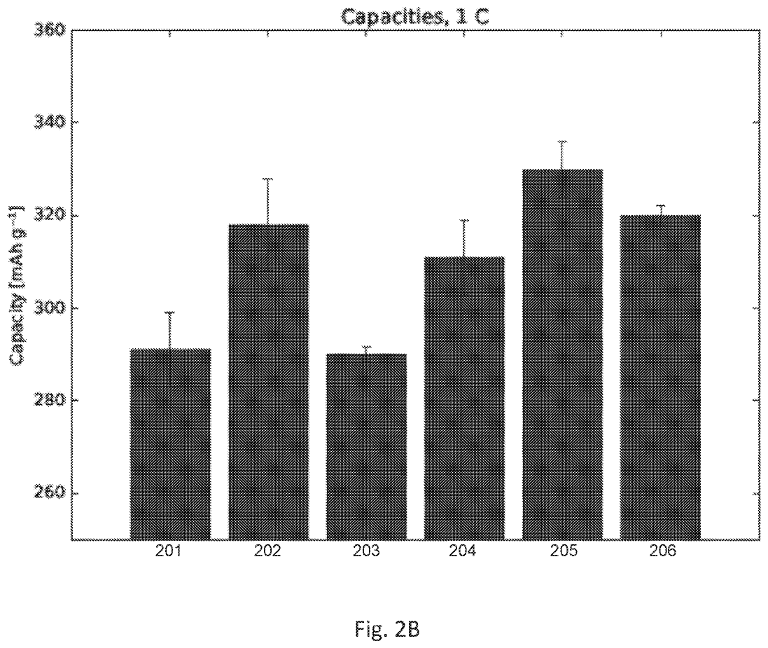

FIG. 3 shows the average capacity measured for the first 10 cycles for some treated and untreated samples. For all 10 cycles, a discharge rate of 60 mAh g-1 (0.2C) was used, that is, a discharge current corresponding to fully discharging the material over a period of 5 hours. The measured capacity has been adjusted to take the added Ni into account. The materials samples used were the cycled (line 301) and fresh (line 302) AB₅ materials, as well as cycled material subjected to ball-milling (line 303) and small-scale ultrasonic treatment (line 304). A clear activation behavior can be seen for the fresh AB₅ alloy sample (line 302), where the capacity increases rapidly during the first few cycles and reaches a steady value after 8-9 cycles. As can be seen in the same figure, the capacity of the ball-milled sample is comparable to that of the fresh hydrogen storage alloy. The increase in capacity for the ball-milled sample compared to the cycled material was approximately 4% when discharging at 60 mA g-1, reaching a capacity of 314 mAh g-1. The small-scale ultrasonicated sample reached a peak capacity of 307 mAh g-1, an increase in capacity of 1.4%. The fresh material reached an average capacity of 313 mAh g-1, which means there was a net increase in discharge capacity for the ball-milling treated material. Even in comparison to the manufacturers specified capacity of 325 mAh g-1, approximately 96% of the specified capacity is regenerated by ball-milling and approximately 94% by ultrasonication.

The cycling results as shown in FIGS. 2a, 2b and 3 demonstrate that ultrasound treatment of the negative electrode powder provides an increase in capacity for both the “Cycled” powder as well as the “Formation” powder at discharge rates of both 0.2 C and 1 C. As the relative capacity gains are very similar between the 0.2 C and 1 C trials, it may be stated that an overall better material seems to be acquired using ultrasonic treatment, regardless of whether the treatment method is small-scale or large-scale.

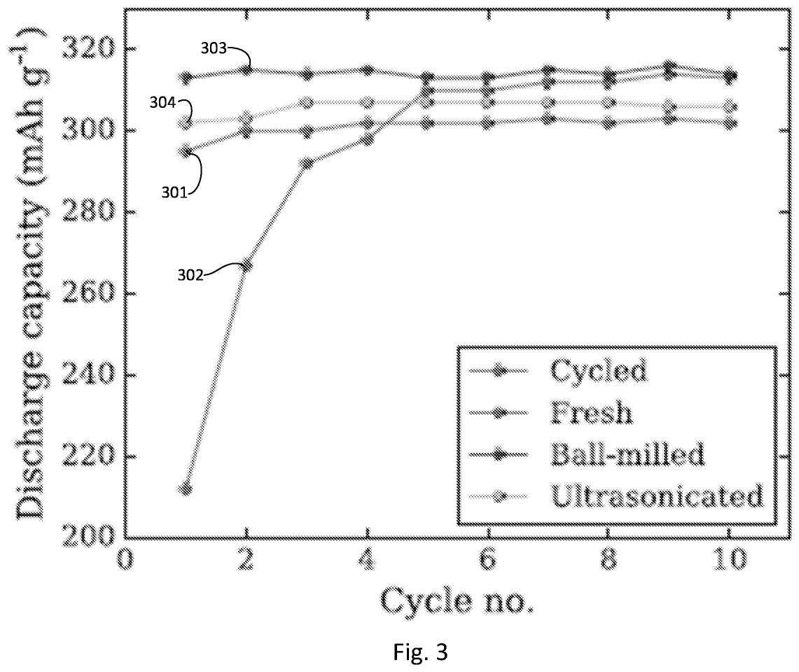

FIG. 4 illustrates schematically the surface of a hydrogen storage alloy upon corrosion. RE(OH)₃ needles (401) are formed at the surface, where RE denotes one or a mixture of rare earth metals. These rare earth hydroxide needles are thought to passivize the alloy. Below the RE(OH)₃ needles (401) a continuous corrosion layer (402) rich in nickel and cobalt nanoparticles is formed at the interface to the bulk alloy (403). This continuous corrosion layer (402) is thought to be highly catalytically active once freed of RE(OH)₃ needles (401), which may explain the excellent discharge capacity of ultrasound treated powders. The actual incidence of RE(OH)₃ needles on the surface of the negative electrode powders was investigated by SEM and powder X-ray diffractometry.

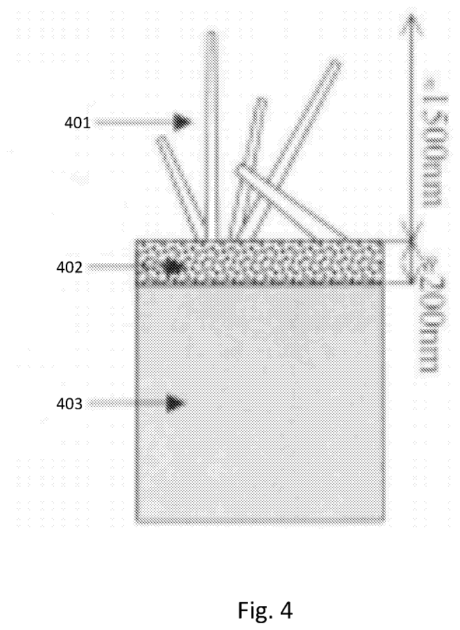

FIGS. 5A and 5B show SEM images of the “Cycled” material prior to ultrasonic treatment (5A) and after small-scale ultrasonic treatment (5B). It is clearly observed that there are far fewer RE(OH)₃ needles on the surface of the ultrasound-treated “Cycled” powder.

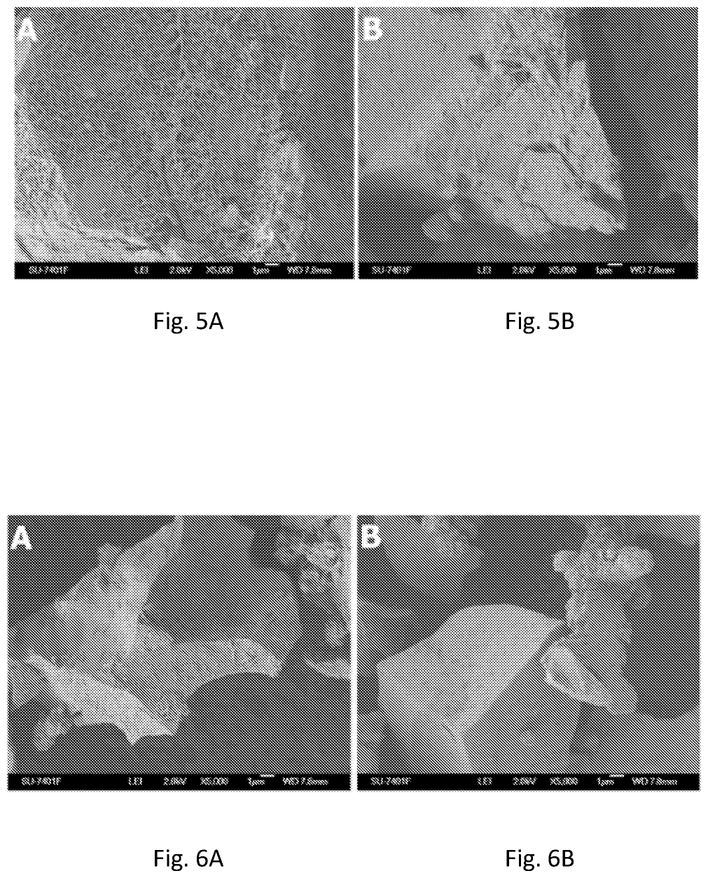

FIGS. 6A and 6B show SEM images of the “Formation” material prior to ultrasonic treatment (6A) and after small-scale ultrasonic treatment (6B). While the difference is not as pronounced as for the “Cycled” material, it may still be clearly observed that there are far fewer RE(OH)₃ needles on the surface of the ultrasound-treated “Formation” powder.

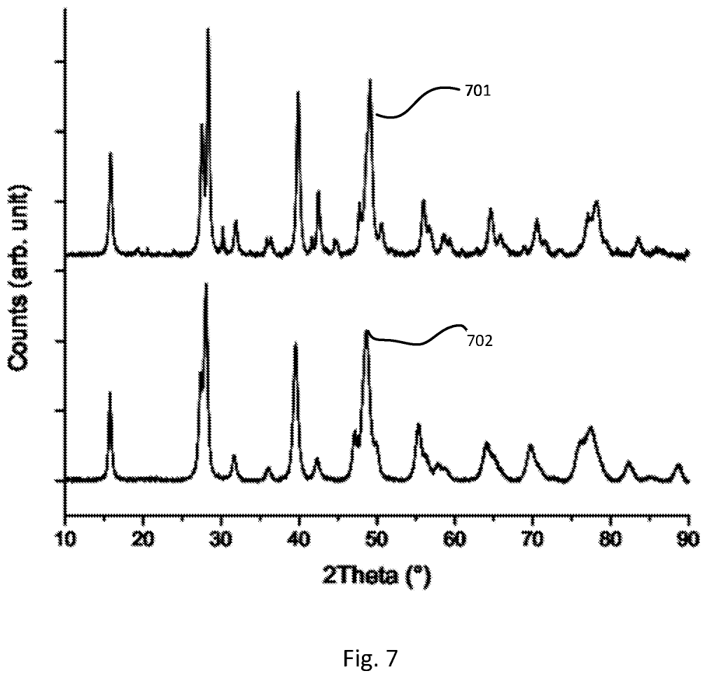

The removal of RE(OH)₃ from the negative electrode powders was confirmed by powder X-ray diffraction of the material suspended in the water decanted after ultrasonication. In FIG. 7, the upper diffractogram (701) is from the material suspended in the water decanted after ultrasonication. The lower diffractogram (702) is La(OH)₃ for comparison. It can be seen that the material suspended in the water decanted after ultrasonication comprises to a large extent La(OH)₃. Peaks which do not match those of lanthanum hydroxide can with good confidence be assigned to small amounts of AB₅ alloy and Ni.

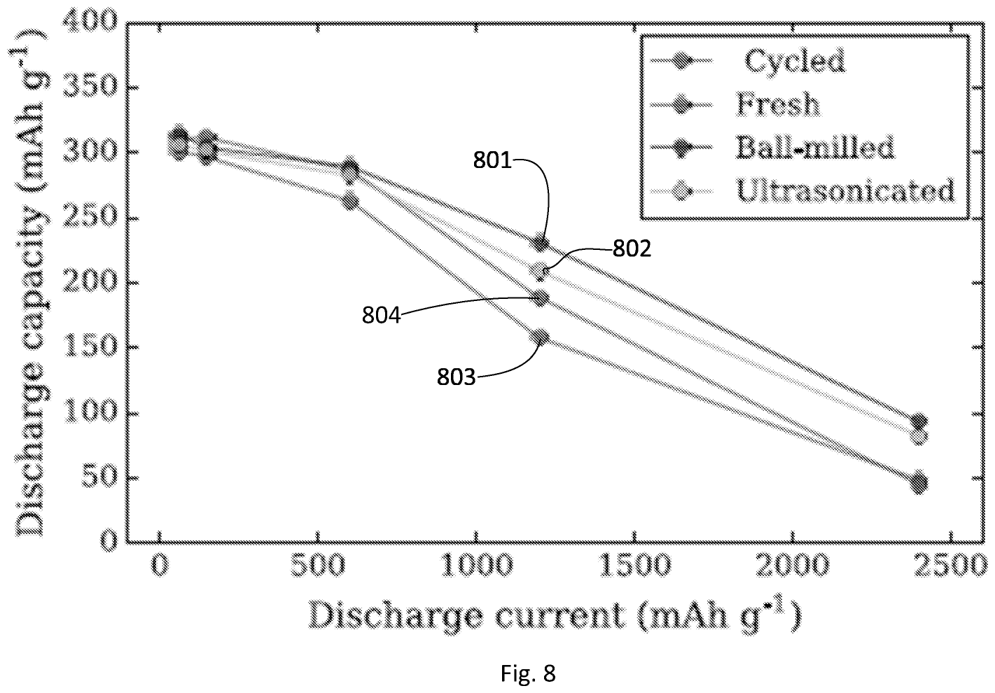

FIG. 8 shows the measured capacities at different discharge rates for the various materials. The ball-milled (line 801) and the ultrasonicated material (line 802) show superior high-rate properties to both the “Cycled” material (line 803) and the fresh “Formation” alloy (line 804). The low- or medium rate properties of the wet-milled samples are comparable to that of the fresh alloy (line 803).

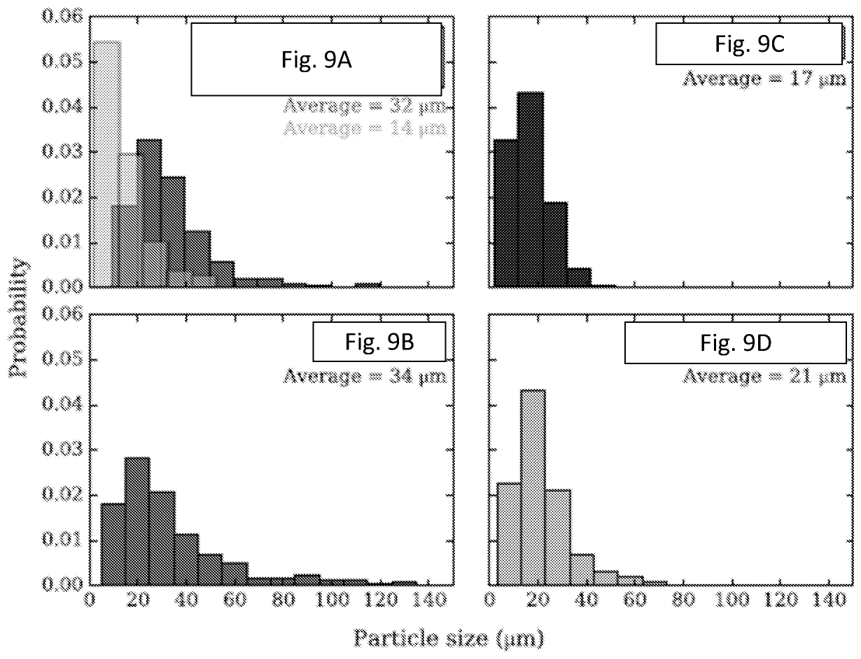

FIGS. 9A-9D show the results from a size analysis by SEM of the “Cycled” and “Formation” powders both prior to and after wet-milling treatment. The particle size distribution is shown with the particle size in μm as the x-axis and the sample particle count (probability) as the y-axis. For each sample, a total of 500 measurements were made. FIG. 9A shows the “Cycled” power prior to treatment. The series denoted ‘Cycled, fragments’ are the measured particle size of fragments seen in a cross-section polished sample of cycled material. FIG. 9B shows the “Formation” powder prior to treatment. FIG. 9C shows the “Cycled” powder after ball-milling. FIG. 9D shows the “Cycled” powder after ultrasonication.

As can be seen in FIGS. 9A-D, a significant reduction in the average (mean) particle size, a reduction in the mode of the particle size distribution, as well as a change in the particle size distribution can be seen for the treated materials. In comparison to the untreated cycled material and the fresh (formation) alloy, the treated materials show less of a right-skewed distribution due to the break-up of larger particles and their distribution shows a greater peakedness. Without wishing to be bound by theory, this likely leads to an improvement of the kinetic properties of the alloy through breaking up already fissured particles, which at the same time increases the surface area. In turn, this break-up may increase the accessibility of active surface sites already formed within the corroded particle clusters. Considering the effect of ball-milling or ultrasonication has on both high-rate properties as well as overall capacity, the increase most likely originates in the breaking up of corroded particle clusters, where the subsequent rough separation performed serves to remove broken up corrosion products and small particle fragments. One plausible reason for the slightly lower gain in capacity for the ultrasonicated material is that the method as performed in the examples may be less efficient than ball-milling in achieving actual fracturing of the particles, leading to a less effective removal of highly oxidized particle fragments.

1. A method of producing an activated negative electrode powder for use in nickel-metal hydride (NiMH) batteries, the method comprising:
a) providing at least one previously cycled NiMH battery;
b) isolating a negative electrode powder from the previously cycled NiMH battery;
c) wet-milling or milling the negative electrode powder, thereby obtaining a mixture of the activated negative electrode powder and a byproduct rich in rare earth hydroxides; and
d) separating the activated negative electrode powder from the byproduct.

2. A method according to claim 1, wherein the wet-milling involves ultrasonication, ball-milling, disc-milling, or jet milling.

3. A method according to claim 1, wherein the wet milling is performed for a period of time sufficient to obtain an activated negative electrode powder having a discharge capacity that is at least 80% of a discharge capacity of freshly manufactured negative electrode powder when measured under the same conditions.

4. A method according to claim 1, wherein the previously cycled NiMH battery has undergone from about 1 to about 20 cycles.

5. A method according to claim 1, wherein the previously cycled NiMH battery has undergone from about 21 cycles to about 2000 cycles, or more than 2000 cycles.

6. A method according to claim 1, wherein the negative electrode powder comprises a hydrogen storage alloy selected from the group consisting of AB, AB₅ alloys, AB₂ alloys, AB₃ alloys, A₂B₇ alloys, and A₅B₂₂ alloys.

7. A method according to claim 1, wherein the negative electrode powder further comprises unalloyed nickel.

8. An activated negative electrode powder obtained by the method of claim 1.

9. An activated negative electrode powder according to claim 8, having an average particle size as measured by SEM of 30 μm or less.

10. An activated negative electrode powder having an average particle size as measured by SEM of 30 μm or less.

11. An activated negative electrode powder according to claim 10, comprising at least 50 wt % of a hydrogen storage alloy selected from the group consisting of AB alloys, AB₅ alloys, AB₂ alloys, AB₃ alloys, A₂B₇ alloys, and A₅B₂₂ alloys.

12. An activated negative electrode powder according to claim 10, having a corrected discharge capacity of at least 300 mAh/g when discharged in a test cell at a rate of 0.2 C.

13. A battery electrode comprising an activated negative electrode powder obtained by the method of claim 1.

14. A battery electrode according to claim 13, further comprising a freshly manufactured negative electrode powder.

15. A battery comprising an activated negative electrode powder obtained by the method of claim 1.
